(19) United States
(12) Patent Application Publication
(10) Pub. No.: US 2005/0089332 A1
(43) Pub. Date: Apr. 28, 2005

(54) Long reach optical transmission over a single fiber

(76) Inventor: Near Margalit, Westlake Village, CA (US)

Correspondence Address: GARY L. SHAFFER, 901 BANKS PLACE, ALEXANDRIA, VA, 22312, US

(21) Appl. No.: 10/956,362

(22) Filed: Oct. 4, 2004

Related U.S. Application Data
(60) Provisional application No. 60/507,967, filed on Oct. 3, 2003.

(51) Int. Cl. H04B 10/20

(52) U.S. Cl. 398/139

(57) ABSTRACT

Devices and methods for effecting and managing the bi-directional transmission of data and communications over a single optic fiber are provided. Methods and devices of the invention utilize fiber-optic transmitters and receivers made for WDM transmission, and at least two slightly different wavelengths, in the 1.5 um range. Devices and methods of the invention facilitate simultaneous bi-directional optical transmission over a long distance, while reducing or eliminating cross-talk.

### RELATED APPLICATIONS

The present application claims priority to U.S. Provisional Application No. 60/507,967, filed Oct. 3, 2003. The cited Application is hereby incorporated by reference in its entirety.

### FIELD OF THE INVENTION

This invention relates to communication over optical fibers, and more specifically with combining signals on optical fibers to effect efficient and accurate bi-directional communication.

### BACKGROUND OF THE INVENTION

Data is transmitted over fiber optic cables mainly because of the unique properties of the fiber-optic transmission medium, namely the inherent wide band of data transmission, and low attenuation through the fiber. Data is transmitted over an optical fiber typically by means of amplitude modulation of a light wave carrier. The properties of the optical fiber as a transmission medium depend on the wavelength of the light wave carrier. The two ranges of light waves wavelengths that are commonly used are the range around 1.3 um (micrometers), and the range around 1.5 um. With transmission over optical fibers, the attenuation of light waves of wavelength of 1.5 um is significantly lower than the attenuation of a wavelength of 1.3 um. For that reason, the 1.5 um wavelength is often preferred by users.

To save cost in installations, optical fibers are often utilized in bi-directional transmission over a single fiber, wherein optical signals are simultaneously transmitted over the same fiber. Different methods are employed to distinguish between the different signals on either side of the optical fiber. In typical prior art applications shown in FIGS. 2 and 3, signals of the same wavelength are simultaneously transmitted in both directions over the fiber. In this type of implementation, the input of each receiver is equipped with an optical directional coupler, which rejects all the signals generated by the local optical transmitter, and accepting only signals generated by the remote optical transmitter. This method of transmission has disadvantages, however. More specifically, when light energy is transmitted over an optical fiber, when the light reaches the end of the fiber, most of the light energy exits the fiber and enters the receiver. However a portion of the light energy is reflected back at the fiber's end, and instead of exiting the fiber, it travels over the fiber back to the transmission end, and enters the receiver at that end. Even though the reflected signal is generated by the local transmitter, the receiver's directional coupler can not reject this signal as it arrives from the remote end of the fiber. This reception of the reflected signal interferes with the reception of the transmission originated at the remote end, and causes a disturbance known as cross-talk.

To alleviate the problems inherent in bi-directional transmission utilizing the same wavelength, the present invention provides devices and methods whereby the respective signals traveling in each direction are transmitted at different wavelengths. Typically the signal in one direction (the first direction) is transmitted at a wavelength of 1.3 um, and the signal in the opposite direction (the second direction) is transmitted at a wavelength of 1.5 um. Although these are preferred frequencies and frequency spreads, other frequencies, or frequency pairs, will work with devices and methods of the invention. Using these methods, receivers of the invention are equipped with filters at their inputs allowing only the desired wavelength to enter the receiver. As such, at any end of the fiber, the transmitter and the receiver are operating on different wavelengths, as is shown by example in FIG. 4. With the present methods of transmission and reception, a reflected signal is rejected by the receivers, because the reflected signals are of a wavelength different from the wavelength to which each receiver is tuned. Thus, many different receivers, or receiver pairs, and many different wavelength pairs are within the scope of the invention.

Bi-directional transmission using two wavelengths such as 1.3 um, and 1.5 um, has its own problems, especially when transmission over a long distance is desired. For example, the attenuation of signals in the range of the 1.3 um and similar wavelengths, limits the distance over which such transmission is feasible.

### SUMMARY OF THE INVENTION

The invention includes methods and devices for effecting the simultaneous bi-directional transmission of optical signals over a single fiber-optic cable, using two slightly different wavelengths, both in the 1.5 um or approximate range. In a fiber-optic transmission method known as WDM, multiple optical waveforms with wavelengths that are approximately 20 nanometers (20 nm) apart are generated and transmitted over optical fibers. In WDM transmission method, each receiver is equipped with a narrow band filter at its input, capable of rejecting wavelengths that differ by 20 nm from the wavelength for which the filter is made. Using fiber-optic transmitters and receivers made for WDM transmission, in bi-directional transmission over a single fiber, as shown in FIG. 1, allows long distance transmission, without the cross-talk attendant to conventional bi-directional optical transmission systems.

In another embodiment, such as the one shown in FIG. 5, multiple simultaneous bi-directional transmissions are facilitated over a single optical fiber. Utilizing this embodiment, multiple simultaneous bi-directional transmissions do not require receivers equipped with wavelength multiplexers as is the case with conventional WDM receivers. As an additional advantage of the invention, the addition of one or more bi-directional transmission links essentially requires the fusing of sections of fiber-optic cables.

### BRIEF DESCRIPTION OF THE DRAWINGS

FIG. 1, shows an embodiment of a bi-directional transmission system described in this invention.

FIG. 2, shows a prior art bi-directional transmission using 1.5 um wavelength.

FIG. 3, shows a prior art bi-directional transmission using 1.3 um wavelength.

FIG. 4, shows a prior art bi-directional transmission using 1.5 um, and 1.3 um wavelengths.

FIG. 5, shows an embodiment of the invention adapted for the transmission of multiple bi-directional signals over a single optical fiber.

### DETAILED DESCRIPTION OF THE INVENTION

In the following detailed description, reference is made to the accompanying drawings, which form a part of the application, and in which are shown by way of illustration, specific embodiments by and through which the invention may be practiced. The embodiments shown in the drawings include only a few examples of the many embodiments disclosed herein, and are provided in sufficient detail to enable those of ordinary skill in the art, to make and use the invention. As one of skill in the art can appreciate, many structural, logical or procedural changes may be made to the specific embodiments disclosed without departing from the spirit and scope of the present invention.

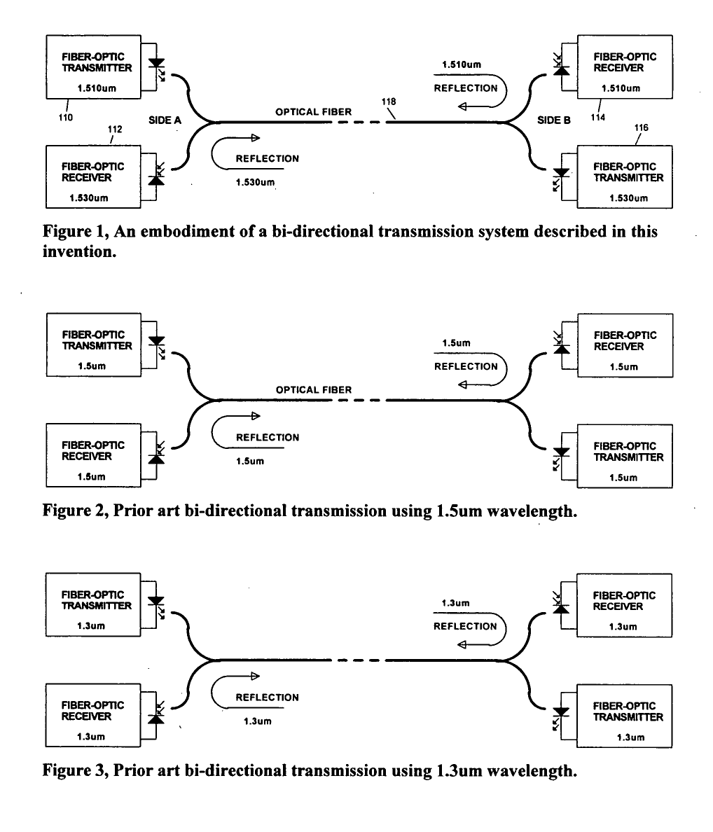

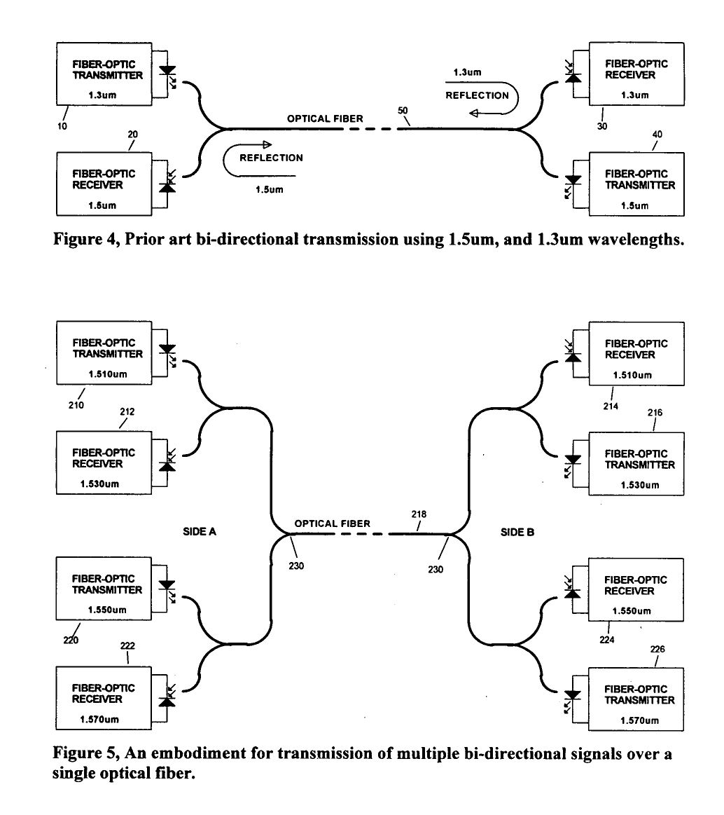

To facilitate a bi-directional transmission link, a pair of wavelength in the range of 1.5 um must be selected. Such wavelengths are separated preferably by at least 20 nm. As shown in FIG. 1, by way of example, side A comprises a fiber-optic transmitter module 110, transmitting at a wavelength of 1.510 um, and a fiber-optic receiver module 112 equipped with an input filter that passes only signals having a wavelength of 1.530 um, and rejecting all other wavelengths. Side B comprises a fiber-optic transmitter module 116, transmitting at a wavelength of 1.530 um, and a fiber-optic receiver module 114 equipped with an input filter that passes only signals having a wavelength of 1.510 um, rejecting all other wavelengths. Signals transmitted in side A by transmitter 110 are received on side B by receiver 114. Signals transmitted in side B by the transmitter 116 are received on side A by receiver 112. Reflections generated on side B as a result of a signal transmitted from side A, travel through fiber cable 118 back to side A, but are rejected by receiver 112 as being of the wrong wavelength for that receiver. Likewise, reflections generated on side A as a result of a signal transmitted from side B, travel through fiber cable 118 back to side B, but are rejected by receiver 114 as being of the wrong wavelength to which that receiver is tuned.

Another exemplary embodiment is shown in FIG. 5, wherein every side comprises of two pairs of optical transmitters and receivers. Even though all of the receivers and transmitters in this embodiment operate with signals of wavelengths in the range of 1.5 um, the operational wavelength of either receiver or transmitter on side A, are each separated from each other by at least 20 nm. The same characteristic pertains to side B, except that the specific wavelengths assigned to transmitters on side A, are assigned to receivers on side B, and the specific wavelengths assigned to transmitters on side B, are assigned to receivers on side A. Thus, wavelength-tuned A-B pairs are provided. According to the example shown in FIG. 5, side A comprises of a fiber-optic transmitter module 210 transmitting at a wavelength of 1.510 um, a fiber-optic receiver module 212 receiving only wavelengths of 1.530 um, a fiber-optic transmitter module 220 transmitting at a wavelength of 1.550 um, and a fiber-optic receiver module 222 receiving only wavelengths of 1.570 um.

Similarly, side B comprises a fiber-optic transmitter module 216 transmitting at a wavelength of 1.530 um, a fiber-optic receiver module 214 receiving only wavelengths of 1.510 um, a fiber-optic transmitter module 226 transmitting at a wavelength of 1.570 um, and a fiber-optic receiver module 224 receiving only wavelengths of 1.550 um. Each of the receivers and transmitters on side A is connected by a fiber-optic cable to a fusion point 230 where all four fibers are fused together with the fiber cable 118, to form a single transmission medium.

Likewise, each of the receivers and transmitters on side B is connected by a fiber-optic cable to a fusion point 230 where all four fibers are fused together with the fiber cable 118, to form a single transmission medium, spanning from side A to side B. Reflections generated on side B as a result of transmissions originated on side A are traveling via the fiber cable 118 back to side A where they are rejected by the receivers of side A 212, 222, as being of the wrong wavelengths, that is, wavelengths to which the subject receiver is not tuned. Reflections generated on side A as a result of transmissions originated on side B are traveling via the fiber cable 118 back to side B where they are rejected by the receivers of side A 214, 224, as being of the wrong wavelengths, that is, wavelengths to which the subject receiver is not tuned.

While the invention has been described in detail in connection with certain preferred embodiments known at the time, it should be readily understood that the methods and devices of the invention are not limited to the disclosed exemplary embodiments. Rather, the present devices, apparatus and methods can be modified to incorporate any number of variations, alterations, substitutions or equivalent arrangements not heretofore specifically described, but which are commensurate with the spirit and scope of the invention.

1. A fiber-optic link adapted and arranged for the simultaneous bi-directional communication using optical signal wavelengths in the range of 1.5 um comprising:
A fiber-optic cable having a first end and a second end;
A first fiber-optic transceiver on the first side of the fiber-optic cable; and
A second fiber-optic transceiver on the second side of the fiber-optic cable.

2. A fiber-optic transceiver on the first side of the fiber-optic cable as in claim 1 comprising:
A fiber-optic transmitter generating optical signal at a first wavelength;
A fiber-optic receiver tuned to receive optical signals of a second wavelength and to reject optical signals of different wavelengths;
A first optical fiber connecting to the optical output of the optical transmitter; and
A second optical fiber connecting to the optical input of the optical receiver.

3. A fiber-optic transceiver on the first side of the fiber-optic cable as in claim 2, wherein the first optical fiber and the second optical fiber are conjoined at their ends not connected to either the optical transmitter or the optical receiver and wherein these optical fibers are further connected to the fiber-optic cable as in claim 1 to form a conduit for optical signals from the optical transmitter on the first side into the first side of the fiber-optic cable and for optical signals generated on the second side of the fiber-optic cable to the optical receiver on the first side.

4. A fiber-optic transceiver on the second side of the fiber-optic cable as in claim 1, comprising:
A fiber-optic transmitter generating optical signal at a second wavelength;
A fiber-optic receiver tuned to receive optical signals of a first wavelength and to reject optical signals of different wavelengths;
A first optical fiber connecting to the optical output of the optical transmitter;
A second optical fiber connecting to the optical input of the optical receiver.

5. A fiber-optic transceiver on the second side of the fiber-optic cable as in claim 4, wherein the first optical fiber and the second optical fiber are conjoined at their ends not connected to either the optical transmitter or the optical receiver and wherein these optical fibers are further connected to the fiber-optic cable as in claim 1 to form a conduit for optical signals from the optical transmitter on the second side into the second side of the fiber-optic cable and for optical signals generated on the first side of the fiber-optic cable to the optical receiver on the second side.

6. A fiber-optic link for simultaneous bi-directional communication using optical signal wavelengths in the range of 1.5 um as in claim 1, wherein the difference in optical wavelength between the first wavelength and the second wavelength is at least 20 nm.

7. A fiber-optic link for simultaneous bi-directional communication using optical signal wavelengths in the range of 1.5 um comprising:
A fiber-optic cable;
A fiber-optic Plug-In transceiver module on the first side of the fiber-optic cable; and
A fiber-optic Plug-In transceiver module on the second side of the fiber-optic cable.

8. A fiber-optic Plug-In transceiver module on the first side of the fiber-optic cable as in claim 7 comprising:
A fiber-optic transmitter generating optical signal at a first wavelength;
A fiber-optic receiver tuned to receive optical signals of a second wavelength and to reject optical signals of different wavelengths;
A first optical fiber connecting to the optical output of the optical transmitter; and
A second optical fiber connecting to the optical input of the optical receiver.

9. A fiber-optic Plug-In transceiver module on the first side of the fiber-optic cable as in claim 8, wherein the first optical fiber and the second optical fiber are conjoined at their ends not connected to either the optical transmitter or the optical receiver and wherein these optical fibers are further connected to the fiber-optic cable to form a conduit for optical signals from the optical transmitter on the first side into the first side of the fiber-optic cable and for optical signals generated on the second side of the fiber-optic cable to the optical receiver on the first side.

10. A fiber-optic Plug-In transceiver module on the second side of the fiber-optic cable as in claim 7, comprising:
A fiber-optic transmitter generating optical signal at a second wavelength;
A fiber-optic receiver tuned to receive optical signals of a first wavelength and to reject optical signals of different wavelengths;
A first optical fiber connecting to the optical output of the optical transmitter; and
A second optical fiber connecting to the optical input of the optical receiver.

11. A fiber-optic Plug-In transceiver module on the second side of the fiber-optic cable as in claim 10, wherein the first optical fiber and the second optical fiber are conjoined at their ends not connected to either the optical transmitter or the optical receiver and wherein these optical fibers are further connected to the fiber-optic cable as in claim 7 to form a conduit for optical signals from the optical transmitter on the second side into the second side of the fiber-optic cable and for optical signals generated on the first side of the fiber-optic cable to the optical receiver on the second side.

12. A fiber-optic link for simultaneous bi-directional communication using optical signal wavelengths in the range of 1.5 um as in claim 7, wherein the difference in optical wavelength between the first wavelength and the second wavelength is at least 20 nm.

13. A fiber-optic link comprising:
A fiber-optic cable;
A fiber-optic transmitter on the first side transmitting at a wavelength in the range of 1.5 um;
A fiber-optic receiver on the first side tuned to receive optical signals of a wavelength in the range of 1.5 um, but different from the wavelength transmitted by the transmitter on the first side by at least 20 nm;
A fiber-optic transmitter on the second side transmitting at a wavelength in the range of 1.5 um, different from the wavelength transmitted by the transmitter on the first side by at least 20 nm, but equal to the receiving wavelength of the receiver on the first side; and
A fiber-optic receiver on the second side tuned to receive optical signals of a wavelength in the range of 1.5 um different from the wavelength transmitted by the transmitter on the second side by at least 20 nm but equal to the transmitting wavelength of the transmitter on the first side.

14. A fiber-optic link as in claim 13, wherein the optical transmitter and the optical receiver on either one side of the fiber-optic cable are combined together in a single Plug-In transceiver module.

15. A fiber-optic link for simultaneous bi-directional communication using optical signal wavelengths in the range of 1.5 um comprising of:
A fiber-optic cable;
A plurality of fiber-optic transceivers on the first side of the fiber-optic cable; and
A plurality of fiber-optic transceivers on the second side of the fiber-optic cable.

16. A fiber-optic link for simultaneous bi-directional communication using optical signal wavelengths in the range of 1.5 um as in claim 15, wherein all of the optical transmitters on the first side of the fiber-optic cable transmit optical signals of wavelengths in the range of 1.5 um and wherein each transmitter transmits an optical signal of a wavelength different from the wavelength transmitted by any other transmitter and further wherein the wavelength difference between any two transmitted optical signals is at least 20 nm.

17. A fiber-optic link for simultaneous bi-directional communication using optical signal wavelengths in the range of 1.5 um as in claim 15, wherein all of the optical receivers on the first side of the fiber-optic cable are tuned to receive optical signals of wavelengths range of 1.5 um and wherein each receiver receives only optical signals of wavelengths different from wavelengths generated by any optical transmitter on the first side of the fiber-optic cable and wherein each receiver is tuned to only receive an optical wavelength different from that received by any other receiver and further wherein the wavelength difference between any two received optical signals is at least 20 nm.

18. A fiber-optic link for simultaneous bi-directional communication using optical signal wavelengths in the range of 1.5 um as in claim 15, wherein all of the optical transmitters on the second side of the fiber-optic cable transmit optical signals of wavelengths in the range of 1.5 um and wherein each transmitter transmits an optical signal of a wavelength different from the wavelength transmitted by any other transmitter and further wherein the wavelength difference between any two transmitted optical signals is at least 20 nm.

19. A fiber-optic link for simultaneous bi-directional communication using optical signal wavelengths in the range of 1.5 um as in claim 15, wherein all of the optical receivers on the second side of the fiber-optic cable are tuned to receive optical signals of wavelengths range of 1.5 um and wherein each receiver receives only optical signals of wavelengths different from wavelengths generated by any optical transmitter on the second side of the fiber-optic cable and wherein each receiver is tuned to only receive an optical wavelength different from that received by any other receiver and further wherein the wavelength difference between any two received optical signals is at least 20 nm.

20. A fiber-optic link for simultaneous bi-directional communication using optical signal wavelengths in the range of 1.5 um as in claim 15, wherein each optical receiver on the first side of the fiber-optic cable is tuned to only receive an optical wavelength generated by one optical transmitter on the second side of the fiber-optic cable and wherein each optical receiver on the second side of the fiber-optic cable is tuned to only receive an optical wavelength generated by one optical transmitter on the first side of the fiber-optic cable.

21. A fiber-optic communication link as in claim 15, wherein each transceiver on the first side of the fiber-optic cable is fitted with two short optical fibers, wherein the first of the said fibers connect to the optical output of the optical transmitter and wherein the second of the said fiber connects to the optical input of the optical receiver and further wherein all the optical fibers are conjoined at their ends not connected to either an optical transmitter or an optical receiver and wherein all these optical fibers are further connected to the fiber-optic cable to form a conduit for optical signals from the optical transmitters on the first side of the fiber-optic cable into the second side of the fiber-optic cable and for optical signals generated on the second side of the fiber-optic cable to the optical receiver on the first side.

22. A fiber-optic communication link as in claim 15, wherein each transceiver on the second side of the fiber-optic cable is fitted with two short optical fibers, wherein the first of the said fibers connect to the optical output of the optical transmitter and wherein the second of the said fiber connects to the optical input of the optical receiver and further wherein all the optical fibers are conjoined at their ends not connected to either an optical transmitter or an optical receiver and wherein all these optical fibers are further connected to the fiber-optic cable to form a conduit for optical signals from the optical transmitters on the second side of the fiber-optic cable into the first side of the fiber-optic cable and for optical signals generated on the first side of the fiber-optic cable to the optical receiver on the second side.

23. A fiber-optic link for simultaneous bi-directional communication using optical signal wavelengths in the range of 1.5 um as in claim 15, wherein one of a plurality of optical transmitters and one of a plurality of optical receivers are combined together to form an optical transceiver and wherein such transceiver is assembled as a single plug-in transceiver module and further wherein the optical communication link is comprised of multiple plug-in transceiver modules.
